(19) United States
(12) Patent Application Publication
(10) Pub. No.: US 2017/0259974 A1
(43) Pub. Date: Sep. 14, 2017

(54) LAMINATE FOIL MATERIAL BEARING LUMINESCENT TAG

(71) Applicant: 2266170 Ontario Inc., Mississauga (CA)

(72) Inventors: YUCHENG FU, Mississauga (CA); LIBERATORE TROMBETTA, Ancaster (CA)

(21) Appl. No.: 15/531,792

(22) PCT Filed: Dec. 1, 2015
(86) PCT No.: PCT/CA2015/051247

§ 371 Date: May 31, 2017

Related U.S. Application Data
(60) Provisional application No. 62/085,747, filed on Dec. 1, 2014.

(51) Int. Cl. B65D 65/40; B32B 38/00; B65D 85/804; B32B 27/08

(52) U.S. Cl. CPC B65D 65/40; B32B 27/08; B32B 38/145; B65D 85/8043; B32B 2439/70; B32B 2307/75; B32B 2307/7244; B32B 2307/584; B32B 2307/422; B32B 2307/416; B32B 2307/412; B32B 2307/31

(57) ABSTRACT

A laminate foil is disclosed for packaging materials such as food stuffs. The laminate foil comprises a transparent film interfacing with a second layer. At the interface of the transparent film and the second layer a printed pattern is provided comprising a luminescent taggant material. The transparent film protects the printed pattern from damage, and prevents contact of the printed pattern with human skin.

### BACKGROUND OF THE INVENTION

### 1. Field of the Invention

The invention relates generally to a laminate foil material bearing a luminescent tag, and more particularly to such foil material suitable for packaging food stuff. The invention encompasses food stuff packaged in the laminate foil material, such as portion packs for brewed beverages.

s2. Description of the Related Art

Prior art products bearing a tag are known. For example, US 2013/0129872 discloses a portion capsule for producing a beverage. The portion capsule has a base element comprising a flange. The flange has an identifier in the form of a gearwheel or gearwheel portion in order to individualize the portion capsule.

WO 2014/001564 discloses a portion capsule with a machine readable identifier. The identifier may be a magnetic material, or an optical tag such as a barcode.

In addition, luminescent materials have been suggested for use in optical tags for items such as portion packs for brewed beverages.

Luminescent materials are materials that absorb light of a first wavelength, and emit light of a second wavelength. In general, the absorbed first wavelength is shorter (i.e., has a higher photon energy) than the emitted second wavelength. A detection system can comprise a light source for emitting light of the first wavelength. The detection system may further comprise a reader for registering light emitted by the luminescent tag. The reader may be provided with a filter that blocks light emitted by the light source, so that in principle only light emitted by the luminescent tag reaches the reader.

The luminescent tag generally is placed so that it can be read from the outside of the product. Being placed on the outside, it is subject to damage, such as scratching and rubbing. If used in a packaging material for a foodstuff, such as a beverage portion pack, the luminescent material of the tag may come into contact with (hot) water used in brewing the beverage, which may lead to contamination of the beverage with the luminescent tag material.

When exposed to ambient light, such as (diffuse) daylight or the artificial light of a home or a supermarket, the luminescent tag may absorb light of the first wavelength and emit light of the second wavelength. The emitted light generally is of a specific color, which may interfere with the overall graphics of the packaging material. Moreover, the color of the emitted light may be perceived as garish and be associated with low quality product, causing a distraction from the desired quality image of the product.

Thus, there is a need for a material bearing a luminescent tag that is protected from outside influences such as rubbing, chafing and scratching. There is a further need for preventing the luminescent tag from coming into contact with the skin of a user, or with food or food ingredients.

There is a further need for a material presenting a luminescent tag having a pleasing appearance under a variety of light conditions generally encountered in a consumer environment.

There is a further need for increasing the signal strength from a luminescent tag.

### BRIEF SUMMARY OF THE INVENTION

The present invention addresses these problems by providing a laminate foil material having a first exposed side and a second exposed side, said laminate foil material comprising a transparent film at the first exposed side, said transparent film facing a second layer forming an interface, said interface being provided with a printed pattern comprising a luminescent taggant material.

The printed pattern comprising the luminescent taggant material forms a luminescent tag. The tag is visible and addressable through the transparent film, but is protected from damage through rubbing, chafing, scratching and the like by the transparent film. The transparent film also prevents the tag from coming into contact with a person's skin or with food components, for example.

In an embodiment the taggant material is mixed with a pigment reflecting ambient light of a desired wavelength. The presence of the pigment overwhelms any light emitted by luminescent tag, without interfering with the functionality of the tag. In an embodiment the pigment is a white pigment, for example TiO₂.

In an embodiment a light reflective layer is provided under the layer comprising the luminescent tag, to increase the strength of the luminescent signal acquired from the tag. This reflective layer may be a metal film, for example an aluminum film, or a layer of white pigment.

Another aspect of the invention comprises a product, for example a consumer product packaged in the laminate foil material of the invention. An example of such consumer product is a beverage portion capsule.

### BRIEF DESCRIPTION OF THE DRAWINGS

FIGS. 1A and 1B show two examples of laminate foil materials according to the present invention.

FIGS. 2A and 2B show two examples of laminate foil materials having enhanced luminescent signal properties.

FIG. 3 shows an example of a printing pattern.

FIGS. 4A, 4B and 4C show CIELAB readings for ink compositions relative to a standard white reference tile.

### DETAILED DESCRIPTION OF THE INVENTION

The following is a detailed description of the invention.

### Definitions

The term “foil material” as used herein means a thin flexible sheet material. The term encompasses polymeric films, such as polyethylene (PE), polypropylene (PP), polyethylene terephtalate (PET), polystyrene (PS), polyamide (PA), and the like; and metal films, such as aluminum (Al).

The term “laminate foil material” as used herein means a foil material comprising two or more layers. The layers may comprise a film, such as a polymeric film or a metal film. Coatings, such as paint or ink, are not considered layers within the meaning of this definition. A transparent varnish coating, by contrast, is considered a layer within the meaning of this definition. The laminate foil material of the invention comprises at least one layer that is transparent.

The term “luminescent” as used herein refers to any material capable of absorbing light of a first wavelength and emitting light of a second wavelength. The emission may be contemporaneous with the absorption. This phenomenon is sometimes referred to as fluorescence. Certain luminescent materials store at least a portion of the absorbed energy, so that emission continues when light of the first wavelength is no longer being made available for absorption. This phenomenon is known as phosphorescence, sometimes colloquially referred to as “glow-in-the-dark.” Luminescent materials for use in the present invention include both fluorescent and phosphorescent materials. For many embodiments fluorescent materials are preferred.

The term “printed” as used herein refers to any method suitable for applying the luminescent material to a film material. The term encompasses printing techniques, painting, spraying, coating, crayoning, and the like. Suitable printing techniques include inkjet printing, laserjet printing, bubblejet printing, screen printing, rotogravure printing, flexo printing, and like such techniques.

In its broadest aspect the present invention relates to laminate foil material having a first exposed side and a second exposed side, said laminate foil material comprising a transparent film at the first exposed side, said transparent film facing a second layer forming an interface, said interface being provided with a printed pattern comprising a luminescent taggant material.

The printed pattern is formed before the transparent film is laminated to the second layer. It may be formed on the transparent layer or on the second layer, provided that after lamination the printed pattern is present at the interface between the transparent film and the second layer. If the printed pattern is provided in the transparent film it must be formed as the mirror image of the pattern desired for the finished product, a technique referred to as reverse printing.

The luminescent taggant material may be an organic luminescent material, for example an organic fluorescent dye, in particular a synthetic organic fluorescent dye. Organic fluorescent dyes are well known in the art, and offer a wide range of options in terms of the wavelengths of the absorbed light and the wavelengths of the emitted light. Suitable examples include perylenes, in particular perylenes having enhanced solubility, such as alkoxylated perylenes. Suitable examples are disclosed in U.S. Pat. No. 7,914,703 B2, the disclosures of which are incorporated herein by reference.

In an embodiment the luminescent taggant material is an inorganic luminescent material. Suitable examples include compounds, for example oxides of rare earth elements. Almost all rare earth elements have luminescent properties, due to the unique electron configurations of these elements, characterized by partially filled f-orbitals.

The absorption wavelength and the emission wavelength of a rare earth element is determined by its electron configuration, but both can be modified through the use of dopants. The selection of an appropriate rare-earth based for use in the present inventions is generally governed by considerations such as the desired absorption wavelength range; the desired emission wavelength range; toxicity; ease of handling; and price. Some of the most commonly used rare earth elements include cerium, europium, and samarium.

Any transparent polymer film may be used in the laminate material of the invention. Examples include comprises polyethylene terephtalate (PET), polypropylene (PP), oriented polypropylene (OPP), polyimide (PA), polylactic acid (PLA), and mixtures thereof. In an alternate embodiment the transparent layer is formed by a varnish coating.

In an embodiment the laminate material may comprise a barrier layer, for example an oxygen barrier layer. Suitable barrier materials are well known in the packaging art. Examples include aluminum, ethylene vinyl alcohol (EVOH), modified nylon, coated polyester, and combinations thereof.

In an embodiment the laminate material comprises a sealant layer. The purpose of the sealant layer is to provide a heat-sealable material allowing a package to be closed by heat sealing. An example of a commonly used sealant layer material is polyethylene (PE).

As mentioned above, the printed pattern may be applied to the transparent film or to the second layer. The transparent film almost invariably consists of an easily printable material. Some second layer materials, such as aluminum, are not easily printable, but other second layer materials, such as coated polyester or PE, are easily printable. If the second layer is easily printable, it is possible to print the pattern on the first layer or on the second layer. It is also possible to print part of the printed pattern on the first layer, and part of it on the second layer.

As a result of the underlying mechanism of luminescence, the absorbed light has a higher energy (i.e., a shorter wavelength) than the emitted light. The absorbed light may be in the ultraviolet, violet, blue or green part of the spectrum. The emitted light may be in the yellow, orange, red or infrared part of the spectrum. In some embodiments the luminescent taggant material has an emission wavelength in the infrared part of the spectrum. The absorbed wavelength may be in an invisible part of the spectrum (ultraviolet or infrared) so that the tag is invisible under normal lighting conditions.

In other embodiments the luminescent taggant material has an emission wavelength in the visible part of the spectrum, for example between 500 nm and 900 nm, preferably between 600 and 750 nm. An advantage of using a luminescent taggant material having an emission wavelength in the visible part of the spectrum is that the emitted light can be detected with an inexpensive light sensor, and that interference from a heat source is not likely. A downside is that the emitted light may be visible to the human eye under ambient light, causing the taggant to interfere with the overall appearance of the laminate material.

It has been found that interference of emitted light from the taggant material with the appearance of the laminate material can be overcome by combining the taggant material with a particulate opaque material, such as a pigment. Preferably the pigment is a white pigment, such as TiO₂. The pigment may be combined with the luminescent taggant material by mixing the two in a common ink or paint composition. The two may also be combined by separate application to the printed pattern. For example, the luminescent taggant material may first be applied to the transparent film material, followed by an application of the pigment. In an alternate embodiment the luminescent taggant material may be applied to the transparent film material, and the pigment may be applied to the second layer.

In a preferred embodiment the printed pattern presents a true white appearance to the human eye. In technical terms this means that black body radiation (such as diffuse sunlight or light from an incandescent light bulb) is reflected by the printed pattern as near black body emission. True white as used herein means a point within the CIELAB color space having L, a and b values each differing less than 2 points from the respective L, a and b values of a standard white reference tile.

The printed pattern, particularly if it has (nearly) true white properties, may serve as background for indicia, for example related to the product for which the laminate foil material is intended. Such indicia may comprise text, a logo, or both. The indicia partly obscure the luminescent taggant material. It has been found that such blocking may be kept within acceptable limits by allowing light transmission through the indicia, using techniques such as dashed font printing, halftone printing, and the like.

As noted hereinabove, the luminescent taggant material may be applied by a printing technique. The luminescent taggant material may be applied as a component of a printing ink. The printing ink may further comprise a particulate opaque material, such as TiO₂. The printing ink may comprise from 1 to 8 wt % of the luminescent taggant material.

The luminescent taggant material component of the ink preferably is an inorganic luminescent taggant material. The luminescent taggant material preferably is in particulate form. The mean particle size may range from 0.01 to 10 μm. The particulate opaque material preferably has a mean particle size of from 0.1 to 6 μm. In particular inorganic taggant materials may be hard enough to cause damage to engraved ink cells on a gravure printing cylinder. Particle sizes of hard taggant materials are preferably around 1 μm or less.

Suitably the printing ink comprises from 10 to 50 wt % of the particulate opaque material. In preferred embodiments the weight ratio of the particulate opaque material and the luminescent taggant material is from 1:1 to 20:1.

The printing ink may further comprise water, a volatile organic compound (VOC), or a mixture thereof. Suitable examples of VOC include compound selected from the group consisting of; n-propyl acetate; n-propyl alcohol; isopropyl alcohol; and mixtures thereof.

It has been found that the signal strength acquired from the luminescent taggant is increased when the layer adjacent to the transparent layer is either white or reflective. This may be accomplished by using a metal, for example aluminum, for this adjacent layer, or by coating the adjacent layer with a white coating.

The laminate foil material may be used in packaging, for example for packaging of a consumer good. The printed pattern forms a tag that may be used in a variety of ways. The tag may be used, for example, for tracking and quality control at a manufacturing location. It may be used in shipping and warehousing logistics, or it may be used to identify the package or its contents to a consumer appliance, such as an oven, a microwave oven, a washing machine, a clothes dryer, an automatic beverage brewer, and the like.

In an embodiment the consumer package is a single serve coffee or tea capsule, and the consumer appliance is a single serve coffee brewer. The tag serves to confirm the presence of the capsule in the brew chamber of the brewer. It may serve to confirm the compatibility of the capsule with the brewer. It may serve to allow the brewer to select an appropriate brewing cycle from a number of available options, etc.

### Description of Illustrative Embodiments/Examples

The following is a description of certain embodiments of the invention, given by way of example only.

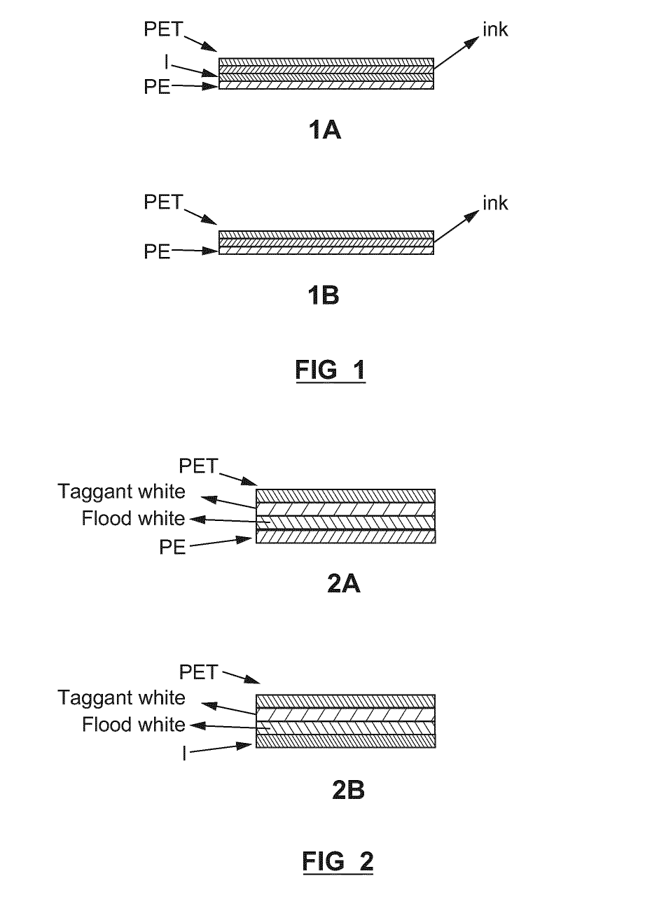

FIG. 1 presents examples of laminate foil materials according to the invention. FIG. 1A shows a laminate comprising a transparent PET layer, an aluminum barrier layer, and a PE sealing layer. The taggant ink and any other printing is present between the transparent PET layer and the aluminum barrier layer.

FIG. 1B shows a laminate foil material comprising a transparent PET layer and a PE sealing layer. The PE layer may comprise cut-out windows, so that a product packaged in this laminate foil material may be visible through the PET layer at the locations of these windows. The ink materials are contained between the PET layer and the PE layer. Generally no ink is present in the window areas of the PE layer.

FIG. 2 presents laminate foil materials comprising a flood white coating for improved acquisition of the signal emanating from the taggant material. FIG. 2A shows a laminate comprising a transparent PET layer and a PE sealing layer. A taggant white ink and a flood white coating are present between the PET layer and the PE layer, the taggant white being adjacent to the PET layer and the flood white coating being adjacent to the PE layer.

FIG. 2B shows a laminate foil material comprising a transparent PET layer and an aluminum barrier layer. A taggant white ink and a flood white coating are present between the PET layer and the Al layer, the taggant white being adjacent to the PET layer and the flood white coating being adjacent to the Al layer. The laminate may comprise additional layers, for example a PE sealing layer underneath the Al layer.

Table 1 below shows the improved signal acquisition achieved when the taggant material is disposed on a white or reflective surface.

TABLE 1
Signal Acquisition (using 4% taggant)

| Laminate foil | Signal strength | Variance (%) |
|---|---|---|
| White ink on PET film | 700 | 100 |
| (reference) | | |
| White ink with flood white | 1280 | 183 |
| coating on PET film | | |
| White ink on Al foil | 750 | 107 |
| Clear ink with flood white | 900 | 129 |
| coating on PET film | | |
| Clear ink on Al foil | 570 | 81 |

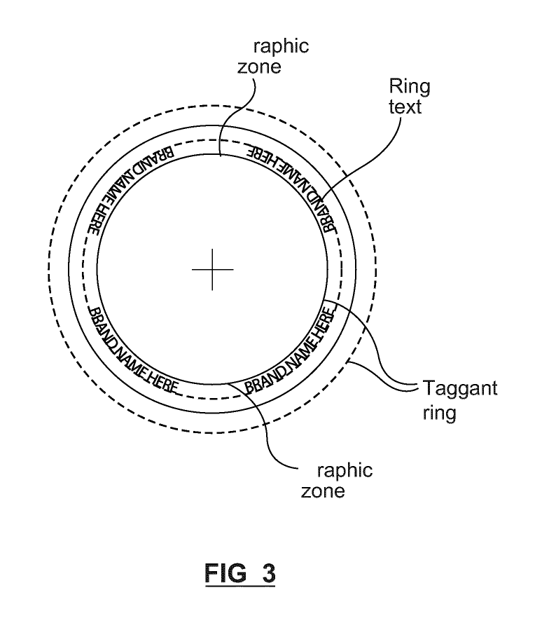

FIG. 3 shows an exemplary circular pattern, which may be present on a peripheral portion of the lid of a beverage capsule. The pattern may be applied to a transparent layer of a laminate by reverse printing. The reverse printing sequence would be (i) black lettering; (ii) graphics colors, which may require one or more printing steps (one step for each color); (iii) taggant ink; and (iv) a white overall flood coat.

In surface printing the printing sequence for the pattern of FIG. 3 would be (i) white overall flood coat; (ii) graphic colors (one or more printing steps); (iii) taggant ink; (iv) black lettering; and (v) transparent varnish.

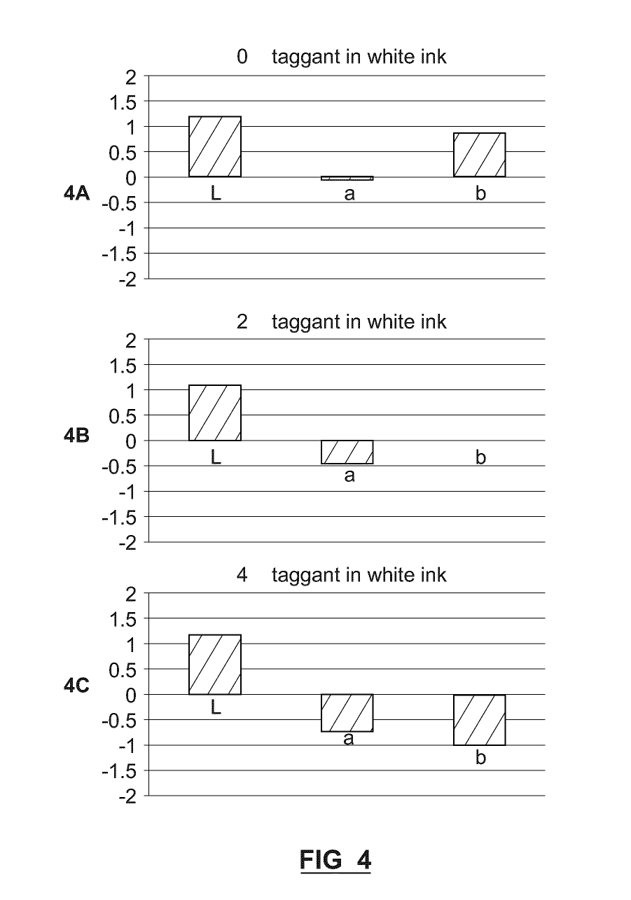

FIG. 4 shows the color reading for three different ink compositions. FIG. 4A shows the CIELAB readings for a white base ink formulation. The L, a, and b values are reported as deviations from a standard white reference tile. The L-reading is about +1.2, which means that the ink has a slightly whiter appearance than the reference tile. The a-reading is −0.1 and the b-reading is +0.8, which are negligible deviations from the reference tile.

FIG. 4B shows the CIELAB readings for the base ink containing 2% of a rare earth taggant material. The L-reading is unchanged from the base ink formulation. As compared to base ink formulation the 2% taggant results in a slight green hue (negative a-reading) relative to the reference tile. This formulation had the same b-reading as the reference tile.

FIG. 4C shows the CIELAB readings for the base ink containing 4% of the rare earth taggant material. The L-reading is unchanged from the base ink formulation. As compared to base ink formulation the 4% taggant results in a slight green hue (negative a-reading) relative to the reference tile. This formulation had a slightly negative b-reading relative to reference tile. The deviations from the reference tile are less than 2 point for each of the L, a and b values, which means that the taggant containing ink formulations are considered true white within the meaning of the present invention.

Thus, the invention has been described by reference to certain embodiments discussed above. It will be recognized that these embodiments are susceptible to various modifications and alternative forms well known to those of skill in the art.

Many modifications in addition to those described above may be made to the structures and techniques described herein without departing from the spirit and scope of the invention. Accordingly, although specific embodiments have been described, these are examples only and are not limiting upon the scope of the invention.

1. A laminate foil material having a first exposed side and a second exposed side, said laminate foil material comprising a transparent film at the first exposed side, said transparent film facing a second layer forming an interface, said interface being provided with a printed pattern comprising a luminescent taggant material.

2. The laminate foil material of claim 1 wherein the second layer has a reflective surface.

3. The laminate foil material of claim 1 or 2 wherein the second layer is coated with a white coating.

4. (canceled)

5. The laminate foil material of claim 1 wherein the luminescent taggant material is an inorganic luminescent taggant material.

6. The laminate foil material of claim 5 wherein the inorganic luminescent taggant material comprises a rare earth element.

7. The laminate foil material of claim 6 wherein the inorganic luminescent taggant material comprises Samarium.

8-12. (canceled)

13. The laminate foil material of claim 1 wherein the luminescent taggant material has an emission wavelength in the infrared part of the spectrum.

14. The laminate foil material of claim 1 wherein the luminescent taggant material has an emission wavelength in the visible part of the spectrum.

15-16. (canceled)

17. The laminate foil material of claim 1 wherein the printed pattern further comprises a particulate opaque material.

18. The laminate foil material of claim 17 wherein the particulate opaque material comprises TiO₂.

19-22. (canceled)

23. The laminate foil material of claim 1 wherein the luminescent taggant material is applied to the transparent film or to the second layer by a printing technique.

24. The laminate foil material of claim 23 wherein the luminescent taggant material is applied to the transparent film or to the second layer as a component of a printing ink.

25. The laminate foil material of claim 24 wherein the printing ink further comprises a particulate opaque material.

26. The laminate foil material of claim 25 wherein the particulate opaque material comprises TiO₂.

27. (canceled)

28. The laminate foil material of claim 24 wherein the luminescent taggant material is in particulate form.

29. The laminate foil material of claim 28 wherein the taggant material has a mean particle size of from 0.1 to 10 μm.

30. (canceled)

31. The laminate foil material of claim 25 wherein the printing ink comprises from 10 to 50 wt % of the particulate opaque material.

32. (canceled)

33. The laminate foil material of claim 25 wherein the weight ratio of the particulate opaque material and the luminescent taggant material is from 1:1 to 20:1.

34-36. (canceled)

37. A consumer package comprising the laminate foil of claim 1.

38. The consumer package of claim 37 which is a beverage portion capsule.
